(19) United States
(12) Patent Application Publication
(10) Pub. No.: US 2009/0283210 A1
(43) Pub. Date: Nov. 19, 2009

(54) Method and Device for the Permanent Connection of Integrated Circuit To a Substrate

(75) Inventor: Uwe Augst, Roding (DE)

Correspondence Address: Ballard Spahr LLP, SUITE 1000, 999 PEACHTREE STREET, ATLANTA, GA, 30309-3915, US

(73) Assignee: Muehlbauer AG, Roding (DE)

(21) Appl. No.: 11/922,714

(22) PCT Filed: Jun. 22, 2006
(86) PCT No.: PCT/EP2006/063469

§ 371 Date: Mar. 20, 2009

(30) Foreign Application Priority Data
Jun. 24, 2005 (DE) 10 2005 029 407.3

(51) Int. Cl. B32B 37/12

(52) U.S. Cl. 156/275.5; 156/379.6

(57) ABSTRACT

The invention relates to a method and an apparatus for permanently joining integrated circuits (1) to at least one substrate (2) arranged therebelow, by means of an adhesive (3) which is arranged therebetween and around the edges of the integrated circuits (1), wherein, in order to cure the adhesive (3), light (19) with a wavelength selected from a wavelength range of 280-900 nm is applied to the upper side and/or underside of the arrangement consisting of the substrate (2) and one of the integrated circuits (1), in order to polymerize the adhesive (3).

The invention relates to a method and an apparatus for permanently joining integrated circuits to at least one substrate arranged therebelow, by means of an adhesive which is arranged therebetween and around the edges of the integrated circuits, according to the preambles of Claims 1 and 7.

To date, various joining methods have been used in the semiconductor processing industry to permanently join so-called integrated circuits (ICs) to the surface of a substrate. By way of example, heated solders are used as joining means between the integrated circuits and the substrate. Alternatively, eutectic joining methods can be used.

The preferred type of joining—inter alia due to the small dimensions of integrated circuits—is the arrangement of adhesives or pastes between the undersides of integrated circuits and the upper side of a substrate, which may also be in strip form, wherein such adhesives and pastes are cured by means of supplied thermal energy.

Due to the thermal energy being transferred to the components involved, such adhesives which cure under the effect of heat often impair these components, for example due to mechanical stress on the surfaces of the integrated circuits and the substrate, which may lead to deformation thereof. The functioning of the integrated circuits may also be impaired by an uncontrolled supply of heat.

Moreover, such a supply of heat results in a demonstrable reduction in long-term stability and long-term quality in terms of the functioning of the integrated circuits.

Accordingly, the object of the present invention is to provide a method and an apparatus for permanently joining integrated circuits to a substrate arranged therebelow, by means of an adhesive, in which it is possible to avoid any damage to the components being caused by the supply of heat.

This object is achieved in terms of the method by the features of Claim 1 and in terms of the apparatus by the features of Claim 7.

The core concept of the invention consists in that, in a method for permanently joining integrated circuits to at least one substrate arranged therebelow, by means of an adhesive which is arranged therebetween and around the edges of the integrated circuits, light with a wavelength selected from a wavelength range of 280-900 nm is applied to the upper side and/or underside of the arrangement consisting of the substrate and one of the integrated circuits in order to cure the adhesive, so as thereby to polymerize the adhesive. Such an addition of light makes it possible to avoid supplying heat and thus to avoid the formation of mechanical stress conditions and surface deformations of the integrated circuits or of the substrate. Instead, the metering of a suitable amount of optical activators within the polymerizable adhesive results in a type of joining which does not lead to any polymerization, that is to say curing of the adhesive, when exposed to daylight, ambient light and/or light used during the production process. Such a polymerization takes place only when light is applied with the predefinable wavelength and a predefinable luminous energy and for a predefinable length of time.

The polymerizing light for curing the adhesive preferably has a luminous energy of at least 5 lumen seconds, preferably at least 100 lumen seconds, and is applied for a duration of 0.1 to 50 seconds, preferably a duration of 8-20 seconds. Only when light is applied with such a minimum luminous energy and for such a minimum length of time at a certain wavelength, which is preferably in the UV wavelength range or near-UV wavelength range, is activation of the optical activators within the adhesive achieved, and thus polymerization of the adhesive.

The actual polymerization of the adhesive takes place in the manner of a chain reaction once the minimum luminous energy has been applied, wherein the application of the minimum luminous energy is maintained during this polymerization process to completely cure the adhesive. Here, the specified preferred durations of 10-20 seconds represent the period starting from the polymerization which begins abruptly when the minimum luminous energy is applied and ending when the chain-reaction-like polymerization process comes to an end.

According to one preferred embodiment, the wavelength is selected from a wavelength range of visible light, namely a range from 400 nm to 750 nm, with UV and/or near-UV wavelength components.

As the apparatus for creating such a permanent join between integrated circuits and a substrate arranged therebelow, use is made of a so-called optotrode-type light source which is designed to distribute light beams emitted by the light source over the surface of planes of the substrate and/or of the integrated circuits, in order to bring about uniform and effective curing of the adhesive. In this case, such a light-applying device or optotrode device is arranged above an upper side of the integrated circuit or below an underside of the substrate, and is adjacent thereto.

Such an optotrode device makes it possible for the light source or light sources to be arranged a short distance away while at the same time distributing the emitted light beams over the surface of the plane of the substrate and of the integrated circuits. The light is applied with the predefined minimum luminous energy as a result, since a reduction in the incident luminous energy and thus no polymerization is obtained if the distance between the light source and the adhesive surfaces is increased. By way of example, if the distance between the light source and the adhesive is doubled, the luminous energy is distributed over four times the surface area, and thus there is only a quarter of the required minimum luminous energy.

Such an optotrode device is characterized by a housing which encases the light source and has light-reflecting inner walls with the exception of one light-transparent wall which faces towards the adhesive surface. Accordingly, in the case of a rectangular housing for example, both the side walls and the rear wall are designed to be light-reflecting on the inner side, and the light-transparent wall which faces towards the adhesive surface, that is to say towards the substrate and/or the integrated circuit, is made for example of glass. As a result, the light beams emitted to the rear and the side of the light source are reflected towards the light-transparent front wall. This increases the luminous energy transmitted to the adhesive surface.

The light-transparent wall is either the underside of the housing, if the optotrode device is arranged above the upper side of the integrated circuit, or the upper side of the housing if the latter is arranged below the substrate. In the latter case, the substrate must be made of a light-transparent material, since otherwise no light can reach the adhesive which is arranged between the upper surface of the substrate and the integrated circuit arranged thereon.

Further advantageous embodiments emerge from the dependent claims.

Advantages and expedient features can be found in the following description in conjunction with the drawing, in which:

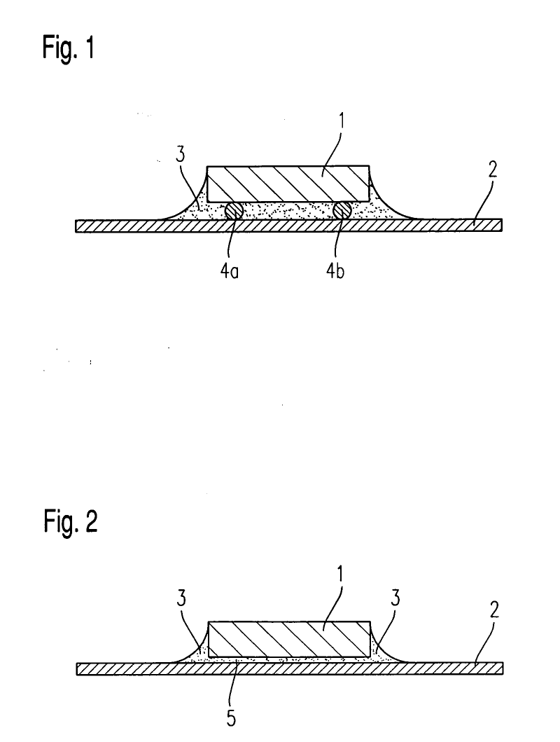

FIG. 1 shows a schematic side view of the arrangement of an integrated circuit on a substrate, which are joined by a method according to one embodiment of the invention;

FIG. 2 shows a schematic side view of another integrated circuit on a substrate, which are joined by the method according to one embodiment of the invention;

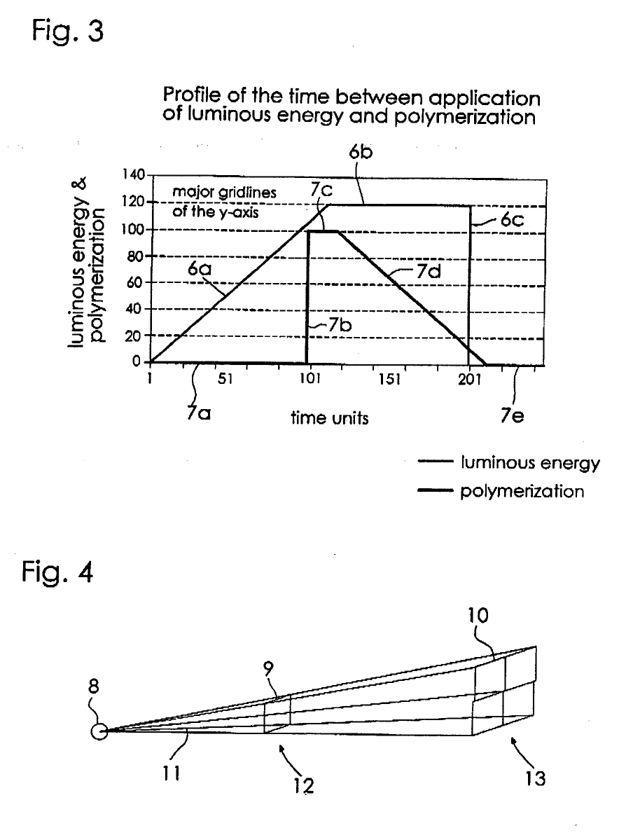

FIG. 3 shows a diagram of the temporal distribution of the luminous energy used in the method according to the invention and the polymerization that takes place;

FIG. 4 shows a perspective schematic view of the distribution of a luminous energy emitted by a light source onto different surface areas as a function of distance;

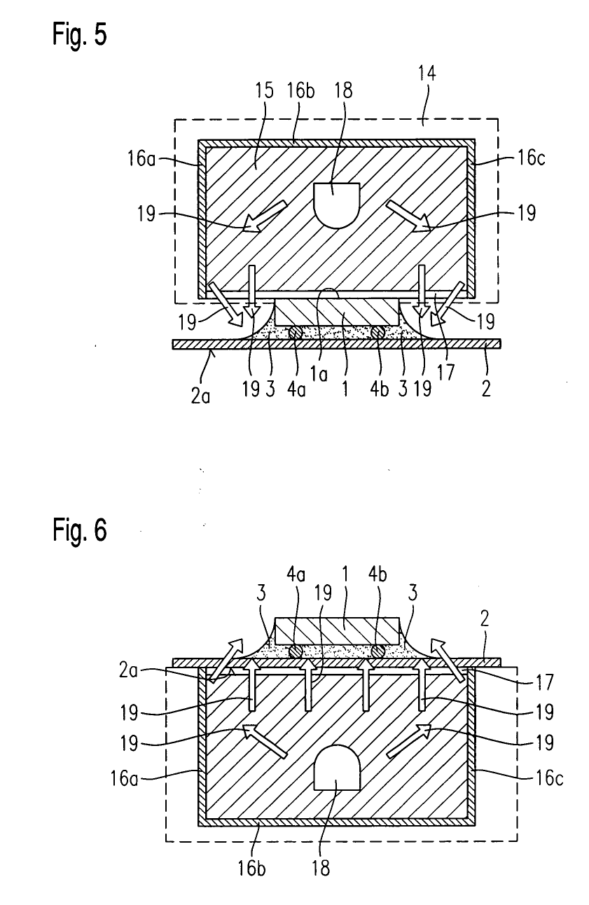

FIG. 5 shows a perspective side view of an apparatus for permanent joining according to a first embodiment of the invention; and

FIG. 6 shows a schematic side view of an apparatus for joining according to a second embodiment of the invention.

FIG. 1 shows a schematic side view of an integrated circuit 1 with a substrate 2, which are joined by means of an adhesive 3 that can be cured by polymerization according to the invention.

Between the integrated circuit 1, which may be a semiconductor component of any type, such as a chip for example, and the substrate 2, there are chip connections (4a, 4b) which through the joining adhesive make permanent contact with further elements, such as an antenna (not shown here) which is arranged on the surface of the substrate 2.

FIG. 2 also shows an integrated circuit 1 with a substrate 2 arranged therebelow, wherein in this case no chip connections or chip connection surfaces are provided in the intermediate space 5 between the integrated circuit 1 and the substrate 2. Moreover, as in the structure shown in FIG. 1, the adhesive is arranged in the edge region of the chip in such a way that the side faces of the chip 1 and the surface of the substrate 2 are covered with adhesive. This leads to a more permanent and high-quality joining of the chip 1 to the substrate 2.

FIG. 3 shows a diagram of the luminous energy applied in the joining method according to the invention and of the polymerization of the adhesive that has taken place, and also the temporal distribution thereof. The diagram shows the luminous energy 6a, 6b and 6c applied to an adhesive surface by means of a light source over time, and at the same time the polymerization 7a, 7b, 7c and 7d which takes place in parallel, so as to evaluate the adhesive based on the applied luminous energy over time.

As can clearly be seen from this temporal profile of the applied luminous energy and of the polymerization that takes place, as the luminous energy 6a increases no polymerization of the adhesive takes place on the curve section 7a until a luminous energy of 100 lumen seconds which is necessary to activate optical activator components contained in the adhesives is applied. The polymerization process then starts abruptly as shown by curve section 7b.

As shown by curve section 7c, the same rate of polymerization is obtained even when the applied luminous energy is increased further to a value of 129 lumen seconds. No further increase in the applied luminous energy is required, as shown by curve section 6b, in order to maintain the chain-reaction-like polymerization as shown in curve section 7d. Rather, after a period of preferably 10 to 20 seconds since the start of polymerization, which also corresponds approximately to the period shown in curve section 7a, the applied luminous energy can be set to zero, as shown in curve section 6c, even though the polymerization as shown in curve section 7d is not yet complete. Polymerization continues until the adhesive is completely cured, as shown in curve section 7e.

FIG. 4 shows a perspective schematic view of the dependence of the applied luminous energy on a distance from the light source 8. If the distance between the light source 8 and a surface area on which light beams 11 impinge, such as an adhesive surface area 9, 10 for example, is doubled, the applied luminous energy at the point 13 is reduced by three-quarters compared to the luminous energy applied at the point 12, due to the surface area 10 being four times greater than the surface area 9. However, since a minimum amount of applied luminous energy is required to bring about the start of polymerization, the smallest possible distance between the light source emitting the light beams and the surface of the adhesive and thus the substrate and the integrated circuit is desired.

Such a small distance between the light source and the adhesive is made possible by a light-applying device or optotrode device 14 as shown in FIGS. 5 and 6. Such an optotrode device comprises a housing 15 with reflective inner walls 16a, 16b and 16c and a light-transparent front wall 17, which allows the light beams 19 emitted by a light source 18 to pass through to the adhesive surfaces 3, some of said light beams being reflected by the inner walls 16a, 16b and 16c onto the light-transparent wall 17 arranged on the underside.

Such a housing 15 with the light source 18 arranged therein is arranged above an upper side 1a of the integrated circuit 1 to be fixed. Once again, chip connection faces 4a, 4b are arranged between the integrated circuit 1 and the substrate 2. It can clearly be seen from the diagram that not only are the light beams 19 distributed by such an optotrode device over the surface of the adhesive 3 arranged at the edges, but also a small distance between the light source 18 and the adhesives 3 is possible without losing any luminous energy. Rather, the necessary minimum luminous energy is maintained so as to start a polymerization which cannot take place solely under the effect of daylight or other ambient light.

FIG. 6 shows an optotrode device according to a further, second embodiment of the apparatus according to the invention. The optotrode device shown therein differs from the optotrode device shown in FIG. 5 in that it is not arranged above the upper side la of the integrated circuit 1, but rather below an underside 2a of the substrate 2. Parts which are the same or which have the same significance are provided with the same references.

As can be seen from comparing the two optotrode devices shown in FIGS. 5 and 6, in the optotrode device shown in FIG. 6 a substrate 2 made of light-transparent material is required in order to allow the light beams 19 to impinge on the surface of the adhesive 3, which is arranged between the integrated circuit 1 and the substrate 2. For the rest, the functioning of the optotrode device shown in FIG. 6 corresponds to that which has already been described in detail with reference to FIG. 5.

All the features disclosed in the application documents are claimed as essential to the invention in so far as they are novel, individually or in combination, with respect to the prior art.

### LIST OF REFERENCES

1 integrated circuit

1a upper surface of the integrated circuit

2 substrate

2a lower surface of the substrate

3 adhesives

4a, 4b chip connections

5 intermediate space

6a, 6b, 6c curve showing luminous energy

7a, 7b, 7c, 7d curve showing polymerization

8 light source

9 first surface area

10 second surface area

11 light beams

12 first point

13 second point

14 light-applying device or optotrode device

15 housing

16a, 16b, 16c reflective inner walls

17 light-transmitting wall

18 light source

19 light beams

1. Method for permanently joining integrated circuits (1) to at least one substrate (2) arranged therebelow, by means of an adhesive (3) which is arranged therebetween and around the edges of the integrated circuits (1), wherein light (19) with a wavelength selected from a wavelength range of 280-900 nm is applied to the arrangement consisting of the substrate (2) and one of the integrated circuits (1), characterized in that light, in order to cure the adhesive (3), is applied to the upper side and/or underside of the arrangement, in order to polymerize the adhesive (3), and that the polymerizing light is applied with a luminous energy (6b) of at least 5 lumen seconds, preferably at least 100 lumen seconds.

2. Method according to claim 1, characterized in that a certain amount of optical activators is added to the polymerizable adhesive (3) such that no polymerization of the adhesive (3) takes place when exposed to daylight, ambient light and/or light used during the production process.

3. Method according to claim 1, characterized in that the application of light with the minimum luminous energy (6b) is maintained for a duration of polymerization (7c, 7d) of the adhesive (3).

4. Method according to any of the preceding claims, characterized in that the wavelength is selected from a wavelength range of visible light, namely in the range from 400 nm to 750 nm, with UV and/or near-UV wavelength components.

5. Method according to any of the preceding claims, characterized in that, for applying the light, use is made of a device (14) for distributing the light beams (19) over the surface of planes of the substrate (2) and/or of the integrated circuits (1), wherein the light-applying device (14) is adjacent to an upper side (1a) of the integrated circuit (1) and/or to an underside (2a) of the substrate (2).

6. Apparatus for permanently joining integrated circuits (1) to at least one substrate (2) arranged therebelow, by means of an adhesive (3) which is arranged therebetween and around the edges of the integrated circuits, wherein a light-applying device (14, 15, 18) with light beams (19) having a wavelength selected from a wavelength range of 280-900 nm, characterized by at least the one light-applying device (14, 15, 18) which is arranged adjacent to and above an upper side (1a) of the integrated circuit (1) and/or adjacent to and below an underside (2a) of the substrate (2) and which is designed to distribute light beams (19) emitted by a light source (18) over the surface of planes of the substrate (2) and/or of the integrated circuits (1), in order to bring about curing of the adhesive (3) wherein the light beams (19) have a luminous energy (6b) of at least 5 lumen seconds, preferably at least 100 lumen seconds.

7. Apparatus according to claim 6, characterized in that the light-applying device (14) comprises a housing (15) which encases the light source (18) and has light-reflecting inner walls (16a, 16b, 16c) and one light-transparent wall (19) which faces towards the substrate (2) and the integrated circuit (1).

8. Apparatus according to claim 6, characterized in that the adhesive (3) contains an amount of optical activators which brings about polymerization of the adhesive (3) when a predefinable luminous energy (6b) is applied for a predefinable length of time.
